(19) United States
(12) Patent Application Publication
(10) Pub. No.: US 2007/0204616 A1
(43) Pub. Date: Sep. 6, 2007

(54) Swing valve for a turbocharger with stacked valve members, and two-stage turbocharger system incorporating same

(75) Inventors: Steven P. Martin, Walnut, CA (US); Andrew F. McGraw, Los Angeles, CA (US)

Correspondence Address: HONEYWELL TURBO TECHNOLOGIES, 23326 HAWTHORNE BOULEVARD, SUITE #200, TORRANCE, CA, 90505, US

(73) Assignee: Honeywell International, Inc.

(21) Appl. No.: 11/368,854

(22) Filed: Mar. 6, 2006

(51) Int. Cl. F02D 23/00; F02B 33/44

(52) U.S. Cl. 60/602; 60/612

(57) ABSTRACT

A swing valve has a pivoting primary valve member for closing a primary valve passage defined in a valve housing, and a pivoting secondary valve member for closing a secondary valve passage defined through the primary valve member. Partial opening of the valve is achieved by pivoting the secondary valve member open while the primary valve member remains closed. Full opening of the valve is achieved by rotating the primary valve member open.

### BACKGROUND OF THE INVENTION

The invention relates to turbochargers in general, and more particularly relates to waste gate or bypass valves for turbocharger systems.

Turbocharger systems are employed for boosting the performance of internal-combustion engines such as gasoline and diesel engines used for passenger automobiles, trucks, marine craft, aircraft, and various other types of vehicles. Turbocharger systems for diesel engines in particular are becoming more and more complex because of the increasing performance demands from such engines. For example, it is becoming increasingly common to employ multiple-turbocharger systems such as serial sequential turbochargers and the like in order to meet the stringent performance requirements.

In such turbocharger systems, there is frequently a need to divert or bypass a flow of gas (whether air on the compressor side of the system, or exhaust gas on the turbine side of the system). For example, in a series turbocharger system, at certain operating conditions it is desirable to cause some or substantially all of the exhaust gas to bypass one of the turbines. Swing valves are often employed for this purpose. A swing valve generally comprises a poppet that pivots between its closed and open positions.

A simple swing valve having a single poppet does not provide the ability to regulate the flow through the valve, since the valve is either open or closed. In addition, the flow area increases rapidly with a single swing valve as the valve begins to open, making the flow control difficult to modulate. Flow control can be provided or improved by employing a dual swing valve arrangement that essentially comprises a large swing valve and a smaller swing valve. Partial opening of the dual swing valve is accomplished by opening only the smaller swing valve. Full opening is accomplished by opening both swing valves. However, the combination of two swing valves each with its own actuator presents and large and awkward assembly that is difficult to package in the vehicle system where space is often at a premium.

### BRIEF SUMMARY OF THE INVENTION

The present invention addresses the above needs and enables other advantages by providing a swing valve having “stacked” valve members or poppets. The swing valve has a compact configuration by virtue of the stacked valve members. The compactness is further facilitated in particular embodiments by an actuating mechanism having actuating shafts that rotate about the same axis and are both driven by a single actuator. However, in other embodiments, multiple actuators can be employed for separately actuating the valve members.

A swing valve in accordance with one embodiment of the invention comprises a valve housing defining a primary valve passage for conducting gas therethrough when the waste gate valve is partially or fully open. A primary valve seat is disposed proximate the primary valve passage (i.e., either in the valve passage or on another component that is connected with the valve housing). The swing valve includes a primary valve member that is movable, by pivoting about an axis, between a closed position in which the primary valve member sealingly engages the primary valve seat and an open position in which the primary valve member disengages the primary valve seat. The primary valve member defines a secondary valve passage extending through the primary valve member, and a secondary valve seat extending about the secondary valve passage.

The swing valve further comprises a secondary valve member that is movable, by pivoting about an axis, between a closed position in which the secondary valve member sealingly engages the secondary valve seat and an open position in which the secondary valve member disengages the secondary valve seat. An actuating mechanism is structured and arranged to pivot the secondary valve member from the closed position thereof to the open position thereof while the primary valve member is maintained in the closed position thereof, thereby partially opening the waste gage valve. The actuating mechanism pivots the primary valve member to the open position thereof to fully open the waste gate valve.

In accordance with one embodiment of the invention, the actuating mechanism includes a primary shaft rotatable about the axis for the primary valve member, the primary valve member being affixed to the primary shaft for rotation therewith, and a secondary shaft rotatable about the axis for the secondary valve member, the secondary valve member being affixed to the secondary shaft for rotation therewith. Advantageously, but not necessarily, the primary and secondary shafts are coaxially arranged with respect to each other such that both primary and secondary valve members rotate about the same axis. The actuating mechanism can further include at least one actuator connected to the primary and secondary shafts for rotating the shafts.

Advantageously, but not necessarily, the primary and secondary shafts are structured and arranged such that the secondary shaft is rotated by an actuator to move the secondary valve member from the closed position to the open position thereof while the primary shaft remains stationary, and the primary shaft defines a stop that is abutted by a portion of the secondary shaft in the open position of the secondary valve member such that further rotation of the secondary shaft causes the primary shaft to rotate with the secondary shaft to move the primary valve member toward the open position thereof. In this manner, both valve members are actuated by a single actuator. The actuator can comprise an electro-hydraulic actuator, an electric actuator, a pneumatic actuator, or the like.

In one embodiment, the swing valve further comprises a spring for biasing the primary shaft in a direction to close the primary valve member.

The primary and secondary valve members can be arranged to open in a direction against the flow of gas through the waste gate valve. Alternatively, the primary and secondary valve members can be arranged to open in a direction with the flow of gas through the waste gate valve.

The swing valve in one embodiment further comprises a primary stop defined in the valve housing against which the primary valve member abuts in the open position thereof. The swing valve can also include a secondary stop defined in the valve housing against which the secondary valve member abuts when the waste gate valve is fully open. The secondary stop can be flexible to absorb and damp vibration of the secondary valve member.

Alternatively, the secondary valve member itself can include a component that dampens and reduces the vibration of the valve member.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an isometric view, partially broken away, showing a swing valve in accordance with one embodiment of the invention, with the valve in a closed position;

FIG. 2 is a front elevation of the swing valve;

FIG. 3 is a sectioned view as seen along Section A-A of FIG. 2, with the valve fully open;

FIG. 4 is a sectioned view as seen along Section B-B of FIG. 2, with the valve fully open;

FIG. 5 is an isometric view of the valve members and their associated shafts, shown in isolation, when the valve is closed;

FIG. 6 is a view similar to FIG. 5, with the valve partially open;

FIG. 7 is a view similar to FIGS. 5 and 6, with the valve fully open;

FIG. 8 is an isometric view of the valve members and shafts in the closed position, showing details of the shaft arrangement;

FIG. 9 is a top elevation of a partial valve assembly in accordance with another embodiment of the invention, with the valve closed;

FIG. 10 is a front elevation of the partial valve assembly;

FIG. 11 is a sectioned view as seen along the Section A-A of FIG. 10, with the valve closed;

FIG. 12 is a view similar to FIG. 11, with the valve partially open;

FIG. 13 is a view similar to FIGS. 11 and 12, with the valve fully open; and

FIG. 14 is a diagrammatic view of a two-stage turbocharger system having a bypass valve in accordance with the invention.

### DETAILED DESCRIPTION OF THE INVENTION

The present inventions now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

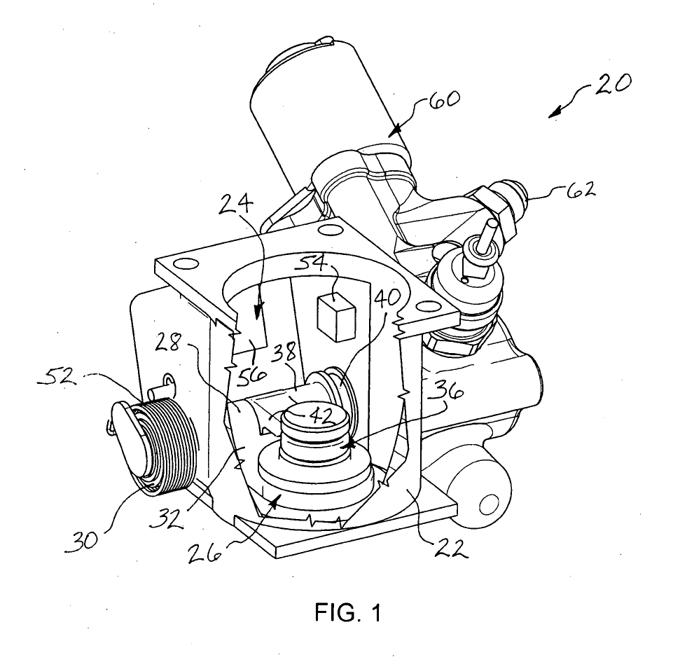

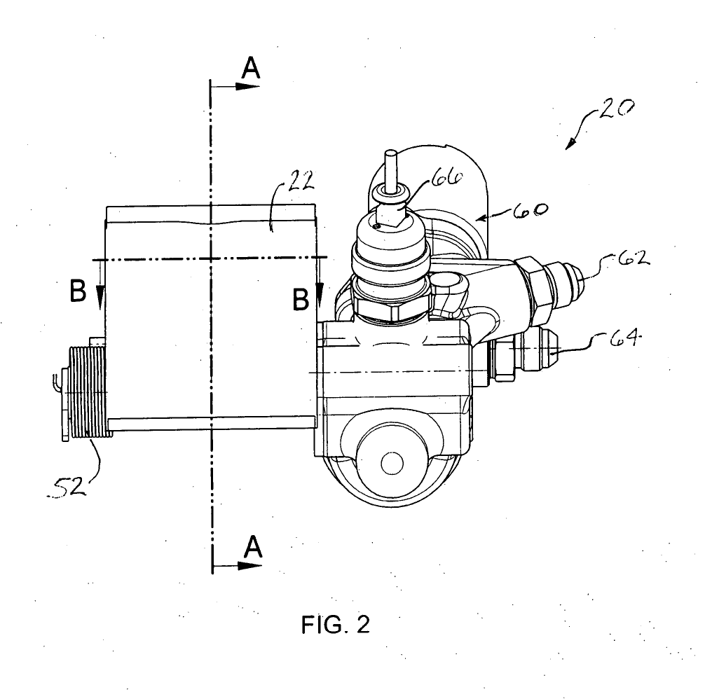

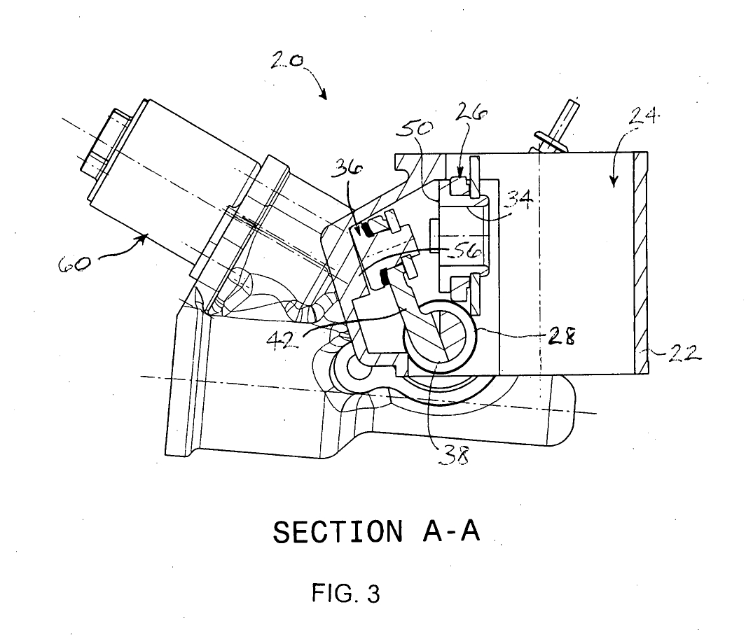

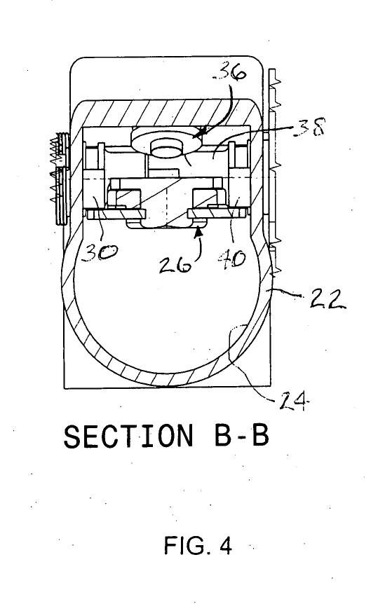

A swing valve 20 in accordance with one embodiment of the invention is illustrated in FIGS. 1-8. The swing valve 20 includes a valve housing 22 that defines a primary valve passage 24 (see particularly FIGS. 3 and 4) extending through the valve housing for conducting a gas (air or exhaust gas, for example) through the swing valve. Disposed in the primary valve passage is a primary valve member 26. The primary valve member is affixed to a primary shaft 28 such that the primary valve member rotates with the primary shaft. The primary shaft 28 is rotatably journaled in a hollow cylindrical journal member 30 that is fixedly mounted in an aperture extending through a side wall of the valve housing 22, and a portion of the primary shaft that projects inwardly from the interior end of the journal member 30 resides within the interior of the valve housing. An arm 32 joined to this interior portion of the primary shaft is joined to the primary valve member 26 such that rotation of the primary shaft 28 in the journal member 30 causes the primary valve member to pivot about the axis of the primary shaft.

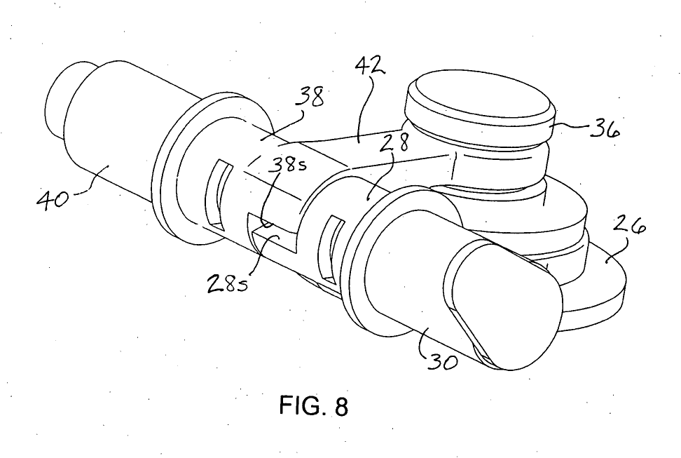

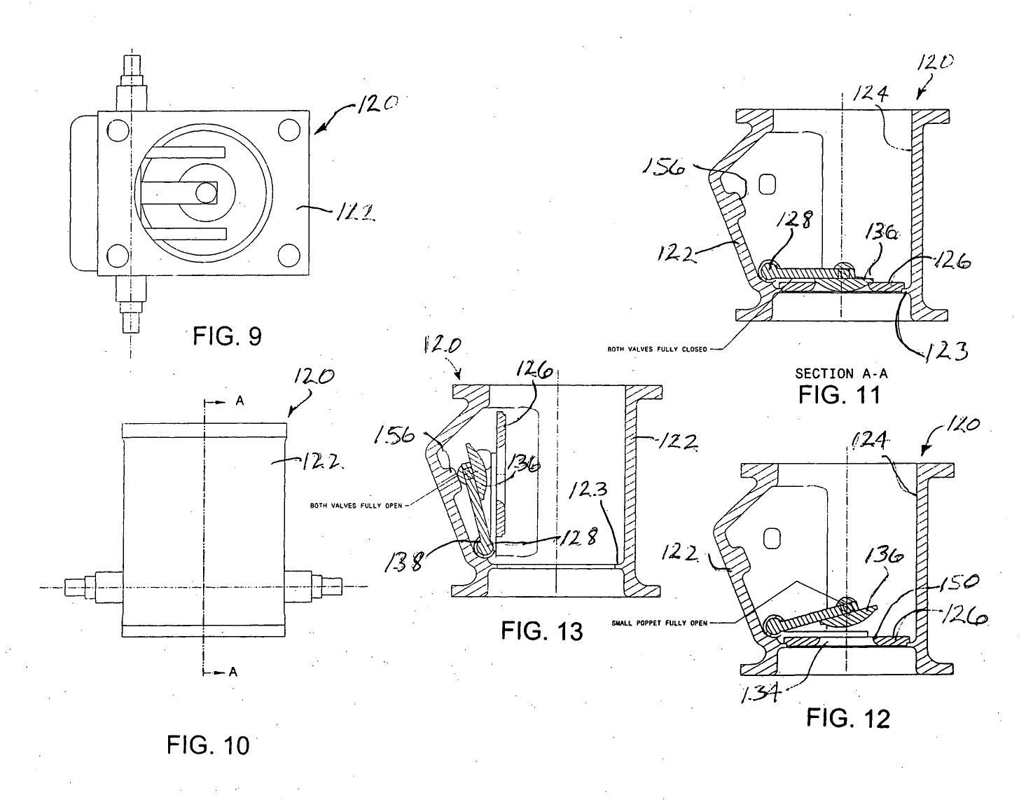

The primary valve member 26 pivots between a closed position (FIGS. 1, 5, and 6) in which the primary valve member blocks the primary valve passage 24 (except that, as further described below, a relatively small amount of flow can occur via the secondary valve passage and valve member), and an open position (FIGS. 3, 4, and 7) in which the primary valve member does not present any significant obstacle to the flow of gas through the primary valve passage. In the closed position, the primary valve member 26 engages a primary valve seat (not shown in this embodiment, but illustrated in the second embodiment of FIGS. 9-12) to seal the primary valve member so that flow is substantially prevented from flowing between the primary valve member and the seat. The primary valve seat either can be disposed within the valve housing 22 (e.g., integrally formed in the valve housing, or separately formed and then installed in the valve housing), or alternatively can be part of another component (not shown) that is attached to the valve housing 22 when the valve 20 is installed in a turbocharger system.

The primary valve member 26 defines a secondary valve passage 34 that extends through the primary valve member. The swing valve 20 further comprises a secondary valve member 36 disposed in the interior of the valve housing 22 and affixed to a secondary shaft 38 such that the secondary valve member rotates with the secondary shaft. The secondary shaft 38 is rotatably journaled in a hollow cylindrical journal member 40 that is fixedly mounted in an aperture extending through a side wall of the valve housing 22, and a portion of the secondary shaft that projects inwardly from the interior end of the journal member 40 resides within the interior of the valve housing. An arm 42 joined to this interior portion of the secondary shaft is joined to the secondary valve member 36 such that rotation of the secondary shaft 38 in the journal member 40 causes the secondary valve member to pivot about the axis of the secondary shaft.

Advantageously, but not necessarily, the axes of the primary and secondary shafts are coaxial. In the embodiment of FIGS. 1-8, the shafts are coaxial, and the shafts have distal end portions that connect to each other in a male/female fashion, as best seen in FIG. 8. The distal end of the primary shaft 28 defines a stop 29s and the distal end of the secondary shaft 38 defines a stop 38s. The distal ends of the shafts are configured such that the secondary shaft 38 is able to rotate for a part of its total rotational travel while the primary shaft 28 remains stationary, until the stop 39s of the secondary shaft abuts the stop 29s of the primary shaft. Then, with further rotation of the secondary shaft, the engagement of the stops 28s, 39s causes the primary shaft to be rotated along with the secondary shaft.

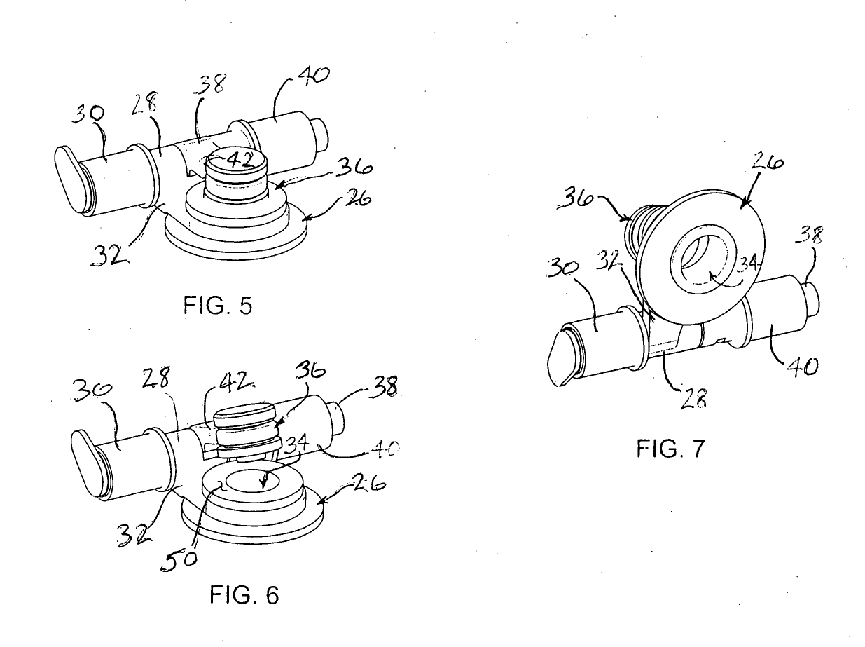

The secondary valve member 36 is thus pivotable by the secondary shaft between a closed position (FIGS. 1 and 5) in which the secondary valve member engages a secondary valve seat 50 (best seen in FIGS. 3 and 6) disposed on the primary valve member 26 so as to close the secondary valve passage 34, and an open position (FIGS. 3, 4, 6, and 7) in which the secondary valve member disengages the secondary valve seat 50 such that gas can flow through the secondary valve passage 34.

The swing valve 20 also can include a bias device such as a torsion spring 52 or the like, for biasing the primary valve member 26 toward its closed position (FIG. 1). In this closed position, the secondary shaft 38 is able to rotate through part of its rotational travel, as noted above, before the stop 39s engages the stop 29s on the primary shaft. Thus, the spring 52 does not bias the secondary valve member 36 all the way to its closed position; instead, the secondary valve member is held in its closed position by the actuator that rotates the secondary shaft, as described below.

The actuator 60 is coupled with the valve housing 22 and includes a rotary actuator member (not shown) that is connected with the secondary shaft 38 such that rotation of the rotary actuator member causes the secondary shaft to rotate with the rotary actuator member. The actuator 60 can comprise any suitable rotary actuator including an electro-hydraulic actuator as illustrated in FIGS. 1-3, an electric actuator, a pneumatic actuator, or the like. In the case of an electro-hydraulic actuator, the actuator includes hydraulic fluid couplings 62, 64 for conducting pressurized hydraulic fluid from a suitable source (not shown) into and out of the actuator, and includes suitable electrical connections for controlling the electrically operable internal valving of the actuator. Additionally, the actuator includes a position sensor 66 for detecting the position of the actuator, and hence the position of the secondary shaft 138. A suitable controller (not shown) connected to the actuator uses the position data provided by the sensor 66 for controlling the positioning of the valve 20.

In operation, the swing valve 20 can be located in a bypass passage of a turbocharger system, such that one portion of the bypass passage connects to one end of the primary valve passage 24 and another portion of the bypass passage connects to the other end of the primary valve passage. With the swing valve in the closed position as shown in FIGS. 1, 5, and 6, gas is prevented from flowing through the primary valve passage 24 and thus the bypass passage of the turbocharger system is closed. In some operating conditions of the turbocharger system, it is desirable to allow a small amount of gas to pass through the bypass passage. Accordingly, at these operating conditions, the actuator 60 is operated to rotate the secondary shaft 38 for a part of its full travel so as to open the secondary valve passage 34 as shown in FIG. 6. The primary valve member 26 is held in its closed position, such as by the spring 52 or by other means.

At other operating conditions, it is desirable to fully open the valve 20 to allow as much flow as possible through the bypass passage. Accordingly, the actuator 60 is operated to further rotate the secondary shaft 38, which causes the stops 28s, 39s to become engaged and thereby causes the primary shaft 28 to rotate along with the secondary shaft, such that the primary valve member 26 is moved to its open position, as best seen in FIG. 3 (and also shown in FIGS. 4 and 7).

The swing valve 20 shown in FIGS. 1-8 and described above is particularly advantageous from the standpoint of compactness because of the usage of a single actuator 60 for actuating both valve members 26, 36. Alternatively, however, where compactness may not be as important a requirement, the swing valve in accordance with the invention can employ two separate actuators for the two valve members.

The swing valve 20 can be designed so that the valve members 26, 36 open in a direction against the flow of gas through the valve passage 24. This provides the advantage that the gas pressure acts in a direction to close the valve, which facilitates good sealing of the valve. The drawback of this arrangement is that higher actuation force is needed to open the valve. Alternatively, the valve can be arranged so that the valve members open in a direction with the flow of gas. This reduces the actuation force for opening the valve, but tends to make it somewhat more difficult to achieve a good seal in the closed condition.

The swing valve 20 advantageously includes one or more primary stops 54 (FIG. 1) against which the primary valve member 26 abuts in its open position. Additionally, there is a secondary stop 56 against which the secondary valve member 36 abuts in its open position, as shown in FIG. 3. The secondary stop 56 can be flexible in order to absorb and damp vibration of the secondary valve member in the fully open position of the valve. This allows the primary valve member to be held against the primary stops 54 without rattling. Alternatively, the secondary valve member can include a vibration-damping member 57 (FIG. 3) for damping vibrations and preventing rattling of the valve member in the open position.

A swing valve 120 in accordance with another embodiment of the invention is illustrated (without any actuator) in FIGS. 9-13. The valve includes a valve housing 122 defining a primary valve passage 124, a primary valve member 126 affixed to a primary shaft 128, and a secondary valve member 136 affixed to a secondary shaft 138. The valve housing 122 defines a primary valve seat 123 that the primary valve member 126 engages in its closed position as shown in FIGS. 11 and 12. This is the primary difference relative to the first valve 20, in which the primary valve seat is provided in another component coupled with the valve 20. In other respects, the valve 120 is generally similar to the first embodiment above.

The secondary valve member 136 engages a secondary valve seat 150 formed on the primary valve member 126 in the closed position (FIG. 11). In this condition, the valve 120 is fully closed. Partial opening is achieved by rotating the secondary shaft 138 to open the secondary valve member 136 as shown in FIG. 12. Full opening is achieved by rotating the primary shaft 128 to open the primary valve member 126 as shown in FIG. 13. In the fully open position, the secondary valve member 136 is held against a secondary stop 156.

The valve 120 can be operated by a single actuator as in the first embodiment, by appropriately configuring the shafts 128, 138 to rotate together once the secondary valve member is open, as in the prior embodiment. Alternatively, a primary actuator can be coupled with the primary shaft 128 to actuate the primary valve member 126, and a secondary actuator can be coupled with the secondary shaft 138 to actuate the secondary valve member 136.

The swing valves in accordance with the invention can be used in various turbocharger system applications wherever there is a desire to provide not just a simple “on/off” function but to additionally provide a flow modulation capability. The swing valves are particularly useful in two-stage turbo arrangements and the like.

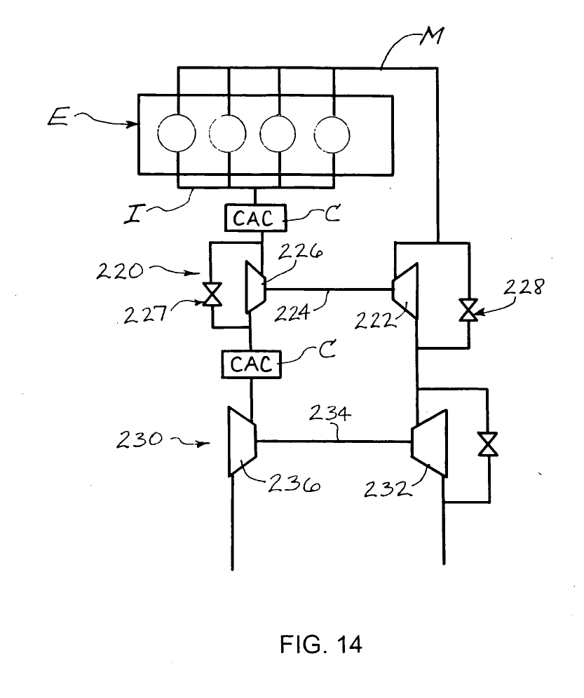

For example, FIG. 14 diagrammatically depicts a two-stage turbocharger system coupled with an internal combustion engine E. The system includes a high-pressure turbocharger 220 and a low-pressure turbocharger 230. The high-pressure turbocharger comprises a high-pressure turbine 222 connected by a shaft 224 to a high-pressure compressor 226. The low-pressure turbocharger 230 comprises a low-pressure turbine 232 connected by a shaft 234 to a low-pressure compressor 236. The compressors 226, 236 are arranged in series such that air is compressed by the low-pressure compressor 236 and is then further compressed by the high-pressure compressor 226 before being delivered to the engine air intake I. Charge air coolers C can be included for cooling the air before it is supplied to the engine intake. The high-pressure compressor can include a bypass passage and valve 227 for selectively bypassing the high-pressure compressor under certain operating conditions.

The high-pressure turbine 222 is coupled with the engine exhaust manifold M for receiving exhaust gas from the engine. The turbines 222, 232 are arranged in series such that exhaust gas is first expanded in the high-pressure turbine 222 and then is conducted through an inter-turbine passage to the low-pressure turbine where the gas is further expanded. The high-pressure turbine includes a bypass passage and valve 228 for selectively bypassing the high-pressure turbine. When the bypass valves 227, 228 are opened, the high-pressure turbocharger 220 is effectively bypassed such that only the low-pressure turbocharger 230 operates to provide boost to the engine.

The turbine bypass valve 228 can comprise a valve as described above in connection with FIGS. 1-13. It is also possible to provide the high-pressure compressor bypass valve 227 as a valve of the type described in connection with FIGS. 1-13.

The valve as described herein can also be used in a two-stage turbocharger system as described in commonly assigned and co-pending U.S. patent application Ser. No. 11/______, filed on ______, bearing attorney docket number H0012012, entitled “TWO-STAGE TURBOCHARGER SYSTEM WITH INTEGRATED EXHAUST MANIFOLD AND BYPASS ASSEMBLY”, the entire disclosure of which is hereby incorporated herein by reference.

The valves described and illustrated herein include two valve members that are stacked. However, the invention also encompasses valves with more than two stacked valve members, arranged generally as described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A swing valve for a turbocharger, comprising:
a valve housing defining a primary valve passage for conducting gas therethrough when the valve is partially or fully open;
a primary valve seat disposed proximate the primary valve passage;
a primary valve member that is movable, by pivoting about an axis, between a closed position in which the primary valve member sealingly engages the primary valve seat and an open position in which the primary valve member disengages the primary valve seat, the primary valve member defining a secondary valve passage extending through the primary valve member, and a secondary valve seat extending about the secondary valve passage;
a secondary valve member that is movable, by pivoting about an axis, between a closed position in which the secondary valve member sealingly engages the secondary valve seat and an open position in which the secondary valve member disengages the secondary valve seat; and
an actuating mechanism structured and arranged to pivot the secondary valve member from the closed position thereof to the open position thereof while the primary valve member is maintained in the closed position thereof, thereby partially opening the valve, and to pivot the primary valve member to the open position thereof, thereby fully opening the valve.

2. The swing valve of claim 1, wherein the actuating mechanism includes a primary shaft rotatable about said axis for the primary valve member, the primary valve member being affixed to the primary shaft for rotation therewith, and a secondary shaft rotatable about said axis for the secondary valve member, the secondary valve member being affixed to the secondary shaft for rotation therewith.

3. The swing valve of claim 2, wherein the primary and secondary shafts are coaxially arranged with respect to each other such that both primary and secondary valve members rotate about the same axis.

4. The swing valve of claim 3, wherein the actuating mechanism further includes an actuator connected to the primary and secondary shafts for rotating the shafts.

5. The swing valve of claim 4, wherein the primary and secondary shafts are structured and arranged such that the secondary shaft is rotated by the actuator to move the secondary valve member from the closed position to the open position thereof while the primary shaft remains stationary, and wherein the primary shaft defines a stop that is abutted by a portion of the secondary shaft in the open position of the secondary valve member such that further rotation of the secondary shaft causes the primary shaft to rotate with the secondary shaft to move the primary valve member toward the open position thereof.

6. The swing valve of claim 5, wherein the actuator comprises an electro-hydraulic actuator.

7. The swing valve of claim 5, wherein the actuator comprises an electric actuator.

8. The swing valve of claim 5, wherein the actuator comprises a pneumatic actuator.

9. The swing valve of claim 5, further comprising a spring for biasing the primary shaft in a direction to close the primary valve member.

10. The swing valve of claim 1, wherein the primary and secondary valve members open in a direction against the flow of gas through the valve.

11. The swing valve of claim 1, wherein the primary and secondary valve members open in a direction with the flow of gas through the valve.

12. The swing valve of claim 1, further comprising a primary stop defined in the valve housing against which the primary valve member abuts in the open position thereof.

13. The swing valve of claim 1, further comprising a secondary stop defined in the valve housing against which the secondary valve member abuts when the valve is fully open.

14. The swing valve of claim 13, wherein the secondary stop is flexible to absorb and damp vibration of the secondary valve member.

15. A two-stage turbocharger system for an internal combustion engine, comprising:
a high-pressure turbocharger comprising a high-pressure turbine driven by engine exhaust gas and connected to a high-pressure compressor;
a low-pressure turbocharger comprising a low-pressure turbine driven by engine exhaust gas and connected to a low-pressure compressor;
an exhaust system arranged to receive exhaust gas from the engine and supply the exhaust gas to the turbines, the exhaust system defining an inter-turbine passage connected between a discharge of the high-pressure turbine and an inlet of the low-pressure turbine, and further defining a bypass passage that bypasses the high-pressure turbine such that exhaust gas routed through the bypass passage proceeds from the engine directly to the inlet of the low-pressure turbine; and
a bypass valve disposed in the bypass passage, the bypass valve being movable between a closed position closing the bypass passage and an open position opening the bypass passage, the bypass valve comprising:
a valve housing defining a primary valve passage for conducting gas therethrough when the waste gate valve is partially or fully open;
a primary valve seat disposed proximate the primary valve passage;
a primary valve member that is movable, by pivoting about an axis, between a closed position in which the primary valve member sealingly engages the primary valve seat and an open position in which the primary valve member disengages the primary valve seat, the primary valve member defining a secondary valve passage extending through the primary valve member, and a secondary valve seat extending about the secondary valve passage;
a secondary valve member that is movable, by pivoting about an axis, between a closed position in which the secondary valve member sealingly engages the secondary valve seat and an open position in which the secondary valve member disengages the secondary valve seat; and
an actuating mechanism structured and arranged to pivot the secondary valve member from the closed position thereof to the open position thereof while the primary valve member is maintained in the closed position thereof, thereby partially opening the waste gage valve, and to pivot the primary valve member to the open position thereof, thereby fully opening the waste gate valve.

16. The two-stage turbocharger system of claim 15, wherein the actuating mechanism includes a primary shaft rotatable about said axis for the primary valve member, the primary valve member being affixed to the primary shaft for rotation therewith, and a secondary shaft rotatable about said axis for the secondary valve member, the secondary valve member being affixed to the secondary shaft for rotation therewith.

17. The two-stage turbocharger system of claim 16, wherein the primary and secondary shafts are coaxially arranged with respect to each other such that both primary and secondary valve members rotate about the same axis.

18. The two-stage turbocharger system of claim 17, wherein the actuating mechanism further includes an actuator connected to the primary and secondary shafts for rotating the shafts.

19. The two-stage turbocharger system of claim 18, wherein the primary and secondary shafts are structured and arranged such that the secondary shaft is rotated by the actuator to move the secondary valve member from the closed position to the open position thereof while the primary shaft remains stationary, and wherein the primary shaft defines a stop that is abutted by a portion of the secondary shaft in the open position of the secondary valve member such that further rotation of the secondary shaft causes the primary shaft to rotate with the secondary shaft to move the primary valve member toward the open position thereof.
